(19) United States
(12) Patent Application Publication
(10) Pub. No.: US 2015/0229269 A1
(43) Pub. Date: Aug. 13, 2015

(54) METHOD AND EQUIPMENT FOR TESTING PHOTOVOLTAIC ARRAYS

(71) Applicants: James Rand, Landenberg, PA (US); Mason Reed, Perry Hall, MD (US); Eric Daniels, Frederick, MD (US)

(72) Inventors: James Rand, Landenberg, PA (US); Mason Reed, Perry Hall, MD (US); Eric Daniels, Frederick, MD (US)

(21) Appl. No.: 14/616,373

(22) Filed: Feb. 6, 2015

Related U.S. Application Data
(60) Provisional application No. 61/936,937, filed on Feb. 7, 2014.
(60) Provisional application No. 62/088,737, filed on Dec. 8, 2014.

(51) Int. Cl. H02S 50/15

(52) U.S. Cl. CPC H02S 50/15

(57) ABSTRACT

Devices and processes are provided configured to test electrical and physical function of photovoltaic modules at the location where the photovoltaic modules are installed and without having to disconnect the photovoltaic modules from their mechanical support or electrical circuits.

### CROSS-REFERENCE TO RELATED APPLICATIONS

This application claims the benefit of the priority date of provisional Application No. 61/936,937, filed Feb. 7, 2014 and provisional Application No. 62/088,737, filed Dec. 8, 2014, each of which is hereby incorporated herein by reference in its entirety.

### BACKGROUND OF THE INVENTION

Evaluating the quality of Photovoltaic (PV) modules in the field is a difficult task. The presently known technology and approaches typically call for the modules to be disconnected from their electrical connections (string) and mechanically removed from their support structure, packaged, and then taken to a tester specifically designed to evaluate the modules. Modules are then quantitatively tested for power generation and leakage current. Clear specifications exist for these testing parameters and warrantees provide for the module to perform at a certain level for a fixed period of time, for example, up to 25 years. These tests can positively identify a sub-standard module, but rarely pinpoint the actual defect driving the low performance of the module.

Solar module manufacturers today are supported by UL 1703, IEC 61215 standards and CEC guidelines that establish minimum testing criteria for photovoltaic products. Modules that successfully pass these well-established standard tests are deemed to be capable of long and safe field operation. Some manufacturers have incorporated additional advanced module tests such as Infrared and Electro-Luminescence (IR and EL) in their in-house quality control processes to better identify module manufacturing defects to further improve module quality. While such tests are not required by the certification standards established by the testing agencies, these tests are of great benefit in identifying defects that may over time lead to safety hazards or catastrophic failures when the modules are deployed in the field. However, even when manufacturers ship defect-free photovoltaic modules, additional damage may occur through transport and handling during site construction or over the years after commissioning as a result of poor maintenance practices.

The EL test typically requires that the module be biased with an external power supply and that the module be in relative darkness. The IR and EL tests are qualitative at this time, but it is foreseeable that they will become quantitative in the future. The EL and IR tests are very good at detecting defects within the PV module's solar cells and electrical circuits such as a broken solar cell, open connector, hot or failed diodes and/or electrical shunt. However, the EL and IR tests are primarily carried out in laboratory settings with precisely controlled conditions. Some mobile labs have also been introduced to conduct such testing in the field. These lab and mobile testing units however, require that the solar modules be mechanically and electrically removed from the array, with the exception of the IR test, which can be carried out with a camera taken to the field. In particular, it is known that a solar module may be imaged by applying a forward or reverse electrical bias on the module and that micro-fractures and other cell defects as well as diode and circuit irregularities can be identified by utilizing cameras that capture infrared light emitted by the panels.

Reports of underperforming systems are becoming increasingly common. System owners and operators are reporting power losses of 3 to 12% or more, often within the first 2 to 5 years of operation. To counteract these system performance problems, some EPC (engineering, procurement, construction) firms, financiers and module manufacturers have increased quality measures by offering factory witness programs and module sampling upon receipt at the site. Unfortunately, these are measures that increase cost and have limited impact on module damage that may be generated at the site and over the life of the system.

Thus, methods and systems are needed that overcome the disadvantages of the above-discussed test methods and systems and provide simple and cost-efficient ways to test photovoltaic modules without removing the photovoltaic modules from the array.

### SUMMARY OF THE INVENTION

Generally, described herein are methods and systems that provide for the performance of infrared (IR), electroluminescence (EL), and other applicable tests on photovoltaic modules as they are installed in the field (i.e., in situ) and without having to remove the photovoltaic modules from the arrays. The methods and systems described herein greatly simplify the logistics and cost associated with solar module diagnostics. Furthermore, by providing for the photovoltaic modules to be tested in situ as they are installed in the field without having to mechanically or electrically remove the modules from their array system, the methods and systems described herein reduce and/or eliminate potential damage to the photovoltaic modules that may be caused during module removal, module shipping to an on-site mobile lab or a remote regional lab, and/or module reinstallation. Since it is not required to remove the modules from their circuits or support structures, great volumes of modules can be quickly and economically tested.

While conventional mobile lab testing equipment can be packaged and transported to remote solar sites for field based tests, such equipment usually requires special environmental conditions, consumes great power, is heavy and sizable. Due to the size of the trucks and conditions at the installation site, most of the installed solar panels cannot be reached for testing. Conversely, the test processes described herein have minimal equipment requirements and by way of example, the presently described equipment required to test the photovoltaic modules in situ is designed to fit within suitcase or smaller sized containers for easy transport and movement around the site. In short, the equipment may be carried by the user to the site of testing.

In one approach, the equipment and processes described herein impose an electrical current on a full collection of solar modules (known as a string or an array) that are joined together and individual images of panels and arrays as well as full videos may be captured in one test sequence, thereby greatly reducing logistics, expense and further damage to the modules since they are not removed from their operating circuit or structures.

In one embodiment, a method of testing photovoltaic modules at their installation location includes passing bias current through the photovoltaic modules at night and imaging the photovoltaic modules with a camera.

In one approach, the method includes passing a forward bias current through the modules. In another approach, the method including passing a reverse bias current through the modules. The method may pass a reverse bias current through the modules at night while recording effective resistance at fixed voltages.

The method includes providing a power supply powered by a generator and configured to be movable through the installation location.

In one approach, the camera may be configured to capture an infrared image. The camera may be configured to image light in a range of 0.8 to 1.3 um designed to measure electroluminescent from the solar cells.

By one approach, an entire string of photovoltaic modules is attached to a single power supply. The power supply may be attached to the string at the string combiner box for ease of testing many strings in a short period of time.

The image obtained by the camera may be used to identify open circuits in a string of photovoltaic modules, identify cracked solar cells in a string of photovoltaic modules, identify defective solder joints in a string of photovoltaic modules, identify functioning bypass diodes in a string of photovoltaic modules, identify shorted bypass diodes in a string of photovoltaic modules, or to identify open connections to bypass diodes in a string of photovoltaic modules.

In one approach, a bias point is at or near the maximum power point of an array.

The current may be limited by a power supply to a value in the range of 1 to 10 A.

In one form, the method includes carrying the camera via a flying device such as a small flying device that may be remote controlled, for example, a small helicopter or a drone.

The camera may be wirelessly connected to a computer and configured to acquire and download images, calculate its position by a global positioning system (GPS) or some other means, and controlled to move around the photovoltaic module array to fixed positions that allow the camera to image all of the photovoltaic modules of interest.

By one approach, the method includes tethering the camera to a power supply movable around an array of the photovoltaic modules periodically to provide the camera with a full range of motion needed to cover the array. The camera may be synchronized to the power supply configured to bias the photovoltaic modules so that power from the power supply and the image taken by the camera can be applied at the same time and frequency to allow for less noise in the data and lower power consumption.

The method may include providing a camera assembly that is light weight and configured to be placed directly above a photovoltaic module that is being tested. The camera assembly may include a shroud to exclude ambient light.

The method may include test equipment in a form of one or more devices configured to test the photovoltaic modules and that can be remotely triggered. The test equipment may include a means for shading the photovoltaic modules when required.

By one approach, the method includes using effective resistance to test for the presence of non-functioning bypass diodes. In another approach, the method includes using the effective resistance to identify open circuits, functioning bypass diodes, shorted diodes and open connections to bypass diodes in a string of photovoltaic modules.

In one approach, the method includes providing a fixed forward or reverse voltage bias to a string of the photovoltaic modules. When in the forward bias, the current passing through the string may be equal to or less than a rated short circuit current of the string. When in the reverse bias, the current passing through the string may be approximately 0.4V times the number of bypass diodes in the string to achieve a current in a range of 5% to 50% of the rated short circuit of the string.

In one embodiment, a method of identifying photovoltaic modules in an array of the photovoltaic modules includes coupling a light-emitting or signaling device to a photovoltaic module and imaging the light-emitting device or signaling device with one of a camera, a remote sensor, and a measuring device to determine a location of the photovoltaic module in the array.

In one approach, the method includes providing a fixed reverse voltage bias to the string of photovoltaic modules or an individual photovoltaic module. A typical fixed voltage bias is the number of bypass diodes in the string times 0.4V. In one approach, the fixed reverse voltage bias may be from about 0.5 to about 40V.

In one embodiment, a method of identifying photovoltaic modules at their installation location includes attaching light-emitting or identifiable objects and imaging them with a camera.

The light-emitting or identifiable object may be an infrared emitting source.

The method may include imaging the attached objects by the camera.

In one approach, the method includes using an infrared emitting source to identify a specific photovoltaic module on an image captured by the camera. The camera may be an IR camera. The camera may be configured to image light in the 0.8 to 1.3 um range.

The method may include an infrared emitting source displaying a programmable number to unique identify a specific photovoltaic module.

In one approach, the method includes adding an optical characteristic to a photovoltaic module specifically for the purpose of identification of the photovoltaic module at a later time. In another approach, the method includes adding an identifying feature to the photovoltaic module, where the identifying feature is an electrical sensor, for example, an RFID tag.

In one embodiment, a power generation tester apparatus includes a light source placed directly over a photovoltaic module in an array of photovoltaic modules and configured to permit the photovoltaic module to be tested while the photovoltaic module remains mounted in place in the array.

In one approach, the light source may be an LED tester with limited wavelength range. In another form, the light source is an LED tester with a wavelength range adapted to emulate sunlight, for example, the ASTM AM1.5G spectrum.

The light source may be configured to utilize small area LEDS and optical lenses and to provide a uniform pattern of light over an area of the photovoltaic module being tested.

The light source may be connected to a power supply. The light source may be controlled by a wireless connection to a computer.

The photovoltaic module may be connected to a data acquisition unit configured to bias the photovoltaic module to generate a complete current voltage sweep. The data acquisition unit may be wirelessly connected to a computer.

In one form, the light source is housed in a lightweight holder that is configured to be placed, rolled, or folded onto the photovoltaic module being tested.

In one form, the camera is provided in a camera assembly that is light weight and configured to be placed directly above the photovoltaic module that is being tested.

The light source may be a combination of filament-based lights and LED lights.

In one embodiment, a non-contact method of measuring DC voltage of a photovoltaic panel includes using an Electrostatic meter to measure DC voltage of the photovoltaic panel without contacting the photovoltaic panel.

In one embodiment, a method of testing photovoltaic modules includes sensing a signal including I-V data of a photovoltaic module being tested by a remote or central test station and without disconnecting the photovoltaic module from its electrical circuits.

The central test station may be part of an inverter.

The method may include establishing the signal by an attached or detached radio, analog or digital signaling device to the module, junction box and or its output cable.

The method may include subjecting the photovoltaic module being tested to a light bias, radio bias, or electrical bias at such a frequency that the output of the photovoltaic module being tested can be differentiated from all other modules in the circuit.

In one approach, the method includes establishing a signal frequency with shading applied at one or more predetermined frequencies. The method may include establishing the signal frequency with illumination exceeding ambient illumination.

In one approach, the method includes establishing a signal frequency by using both shade and illumination exceeding ambient illumination.

In one form, means for receiving and/or collecting data sent by a photovoltaic module being tested may be provided via an individual module ground point, or via radio signal that uses the cell circuit like an antenna without a need to disconnect the electrical circuits of the photovoltaic module being tested.

The voltage of the photovoltaic module can be used to localize breaks in strings or shorts in strings or any other type of defect that results in a disturbance to the normal voltage profile across a string. A voltage map of the system could be constructed if an automated method of measuring thousands of voltage points across the field (i.e., locations where the photovoltaic modules are installed). Information within such a map could be processed to locate problems with the system. The measurement of the voltage points could be taken, for example, at the backsheet or glass side of the photovoltaic modules.

### BRIEF DESCRIPTION OF THE DRAWINGS

FIG. 1 shows a photovoltaic module array including a mounting structure and a plurality of solar (i.e., photovoltaic modules) according to an embodiment of the invention;

FIG. 2 shows another embodiment of a photovoltaic module array including an attached camera usable to image a single module;

FIG. 3 shows another embodiment of a photovoltaic module array including multiple attached cameras that can image a single module, or multiple modules;

FIG. 4 shows another embodiment of a photovoltaic module array including a detachable light source (and/or shading apparatus) having a power source;

FIG. 5 shows a photovoltaic module array according to an embodiment of the invention being imaged by an exemplary flying unit including one or more cameras; and

FIG. 6 shows a photovoltaic module array according to an embodiment of the invention imaged by a tethered flying unit including a camera and an optional power supply.

### DETAILED DESCRIPTION OF THE INVENTION

The methods, devices and systems described in the present application provide for the performance of various diagnostic tests on photovoltaic modules at the locations where the photovoltaic modules are installed in the field (i.e., in situ) and without having to remove the photovoltaic modules from the arrays.

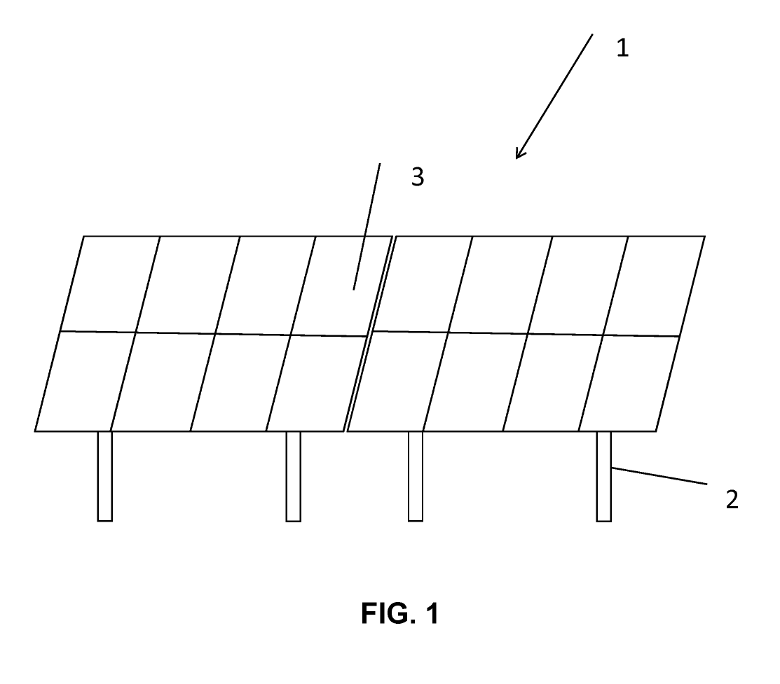

With reference to FIG. 1, an exemplary photovoltaic array 1 is shown. In the illustrated embodiment, the array 1 includes a mounting structure 2 and a number of solar (photovoltaic) modules 3. While the mounting structure 2 is shown in FIG. 1 as a ground mount, it will be appreciated that the photovoltaic arrays as described herein may be used with any suitable alternative mounting configuration, for example, commercial rooftop, residential rooftop, trackers, and build-in photovoltaics (BIPV).

According to an embodiment, a method of testing photovoltaic modules includes a DC power supply passing a controlled level of current through a string of photovoltaic modules. An electrical connection can be made to the string of the photovoltaic modules at a string combiner box. Such a method advantageously provides for the testing of a large number of photovoltaic module strings with minimal movement of the equipment.

The testing of the photovoltaic modules may be carried out via forward biasing of the array at night with an applied current that can be less than or equal to the rated short circuit current of the modules in the string. The forward bias of the panels will result in uniform heating of the photovoltaic modules and the uniformity of the heating can be measured with a camera, for example, an infrared camera.

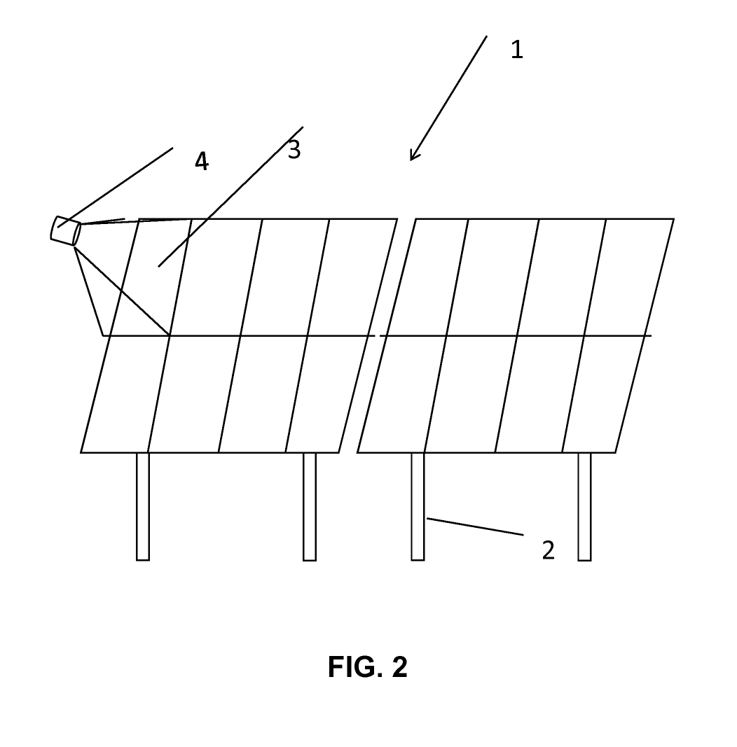

FIG. 2 shows an exemplary photovoltaic array 1 with a removable camera 4 attached to one of the photovoltaic modules 3 in the array 1. The camera 4 may be lightweight and may be used to image the single photovoltaic module 3 as shown in FIG. 2. The configuration as shown in FIG. 2 may be used for EL imaging and/or IR imaging of the photovoltaic modules 3, although each individual image may require a different camera. The string of photovoltaic modules 3 containing the module being imaged by the camera 4 may be biased at a certain current and voltage while the image is taken. Alternatively, just the photovoltaic module being tested could be biased. The image of the photovoltaic module obtained by the camera 4 in FIG. 2 can be transferred via a wireless or a wired connection to a computer located at the location where the photovoltaic modules are installed, for example, at a mobile testing vehicle, or to a computer located at a central testing station. That same computer can operate, and/or monitor, the equipment biasing the array via a wireless or wired connection.

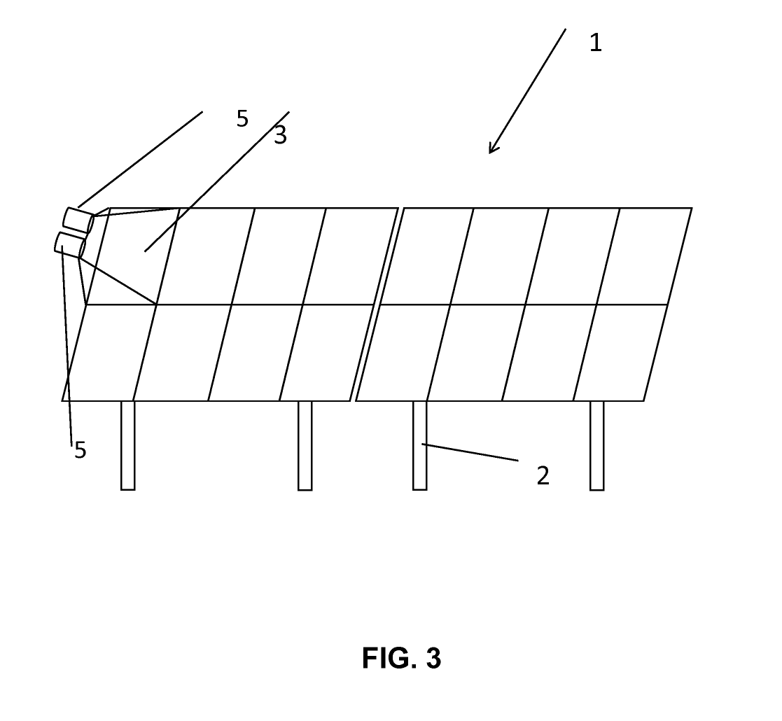

While FIG. 2 shows an exemplary photovoltaic array 1 with one camera 4, it will be appreciated that multiple cameras may be used in accordance with the methods described herein. For example, FIG. 3 shows an exemplary photovoltaic array 1 with multiple cameras 5 being detachably attached to a photovoltaic module 3 in the array 1. The preferably lightweight cameras 5 can image a single module, or multiple modules. The cameras 5 can have different purposes, such as capturing a visual image, a near-infrared image, an infrared image, or an image of a identifying feature for later correlating the image with the specific photovoltaic module being tested.

The camera can be hand held, mounted in a fixed position, or attached to an unmanned aerial vehicle (UAV) such as, for example, a helicopter, plane, or a drone. The flying unit can move around the array imaging many modules. The flying unit can be tethered or not tethered and may include a built-in power supply or a separate power supply.

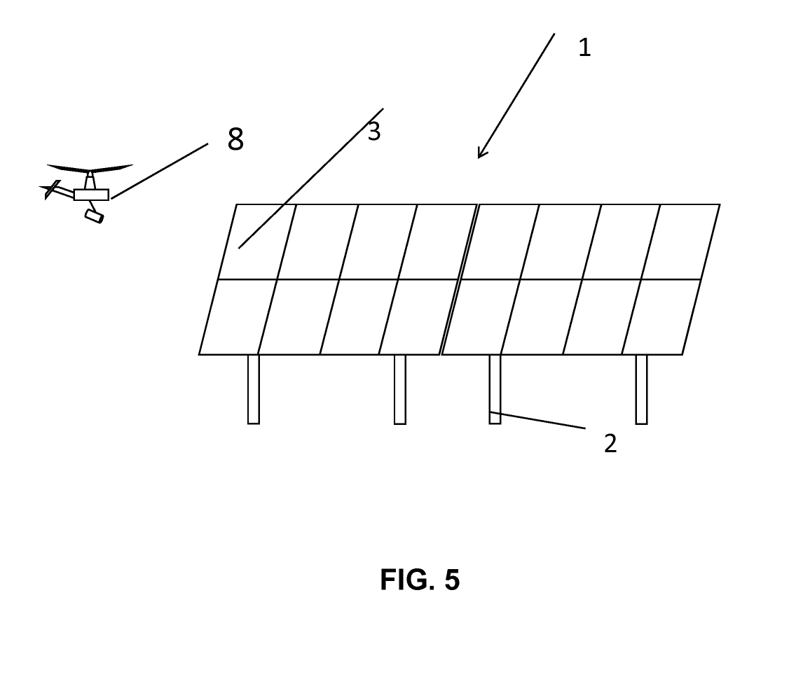

For example, FIG. 5 shows an exemplary photovoltaic array 1 including a photovoltaic module 3 being imaged by a flying UAV unit 8 that includes one or more cameras. All data, instructions, and images acquired by the camera may be sent via one or more signals from the unit 8 via a wireless or wired connection to a control unit and/or a computer at a mobile station or a central station. A configuration as shown in FIG. 5 can be used for EL imaging or IR imaging, assuming that the flying unit 8 incorporates a camera appropriate for EL imaging or IR imaging. The entire string of photovoltaic modules containing the module being tested by the camera of the mobile unit 8 may be biased at a certain current and voltage while the image is taken. Alternatively, just the individual photovoltaic module being tested could be biased. A nearby computer can operate, and/or monitor, the equipment biasing the array wirelessly, or via a wire.

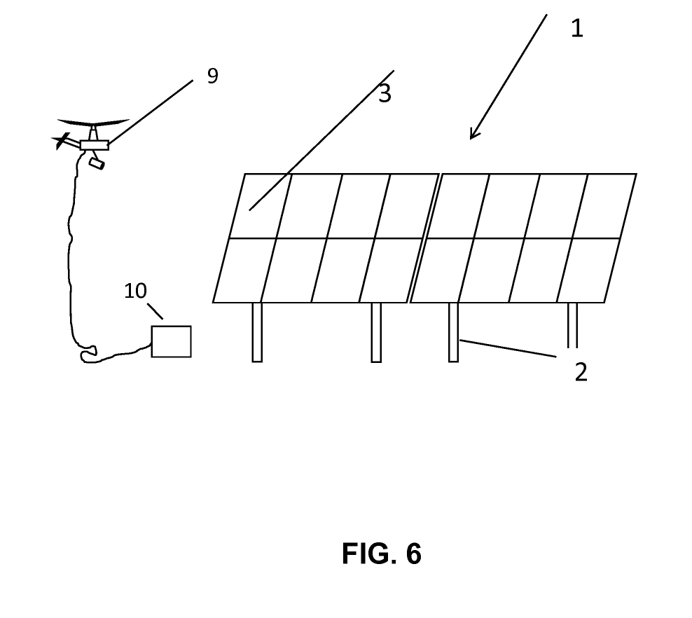

FIG. 6 shows an exemplary photovoltaic array 1 including a photovoltaic module 3 being imaged by an exemplary tethered flying unit 9 carrying one or more cameras. All data, instructions, and images can be transferred by/to the unit 9 to/from a control unit and/or computer located nearby via a wireless or a wired connection. An optional power supply 10 is shown in FIG. 6 that allows a large range of motion of the unit 9. The power supply 10 can be moved to allow for more range of motion, if needed for a particular application. A configuration as shown in FIG. 6 can be used for EL imaging or IR imaging, assuming that the flying unit 8 incorporates a camera appropriate for EL imaging or IR imaging. The entire string of photovoltaic modules containing the module being tested by the camera of the mobile unit 8 may be biased at a certain current and voltage while the image is taken. Alternatively, just the individual photovoltaic module being tested could be biased. A nearby computer can operate, and/or monitor, the equipment biasing the array wirelessly, or via a wire.

The camera can image individual photovoltaic modules or full strings of multiple photovoltaic modules. The camera can be controlled remotely, with images sent wirelessly, or via a wire tether, to a central data collection unit that may be remote to the location where the photovoltaic modules are being tested. The timing of the applied power and the image taken by the camera can be synchronized for increased signal to noise. Images can be taken from behind the photovoltaic modules as well and the camera may be configured to take single images or video of the photovoltaic modules. The relative non-uniformity of the heating of the photovoltaic modules by the current that is revealed through the images acquired and transmitted by the camera conveys detailed information regarding the module(s) being tested, including but not limited to presence of cracks, quality of the solder joints, presence of breaks in the wiring, and other sources of hot spots.

In one embodiment, a test of the photovoltaic modules can be carried out with the DC power supply biasing the string of the photovoltaic modules in reverse bias. Such a test may include recording effective resistance at fixed voltages. The effective resistance of the string in reverse bias will relay information regarding the operation of the bypass diodes. In one exemplary embodiment, a bias voltage of approximately 0.4V times the number diodes in the string of the photovoltaic modules is sufficient to pass a current on the order of 10% of the short circuit current of the modules. If that level of bias voltage does not result in the current flow expected, that indicates that the bypass diodes are not functioning, which is a potentially dangerous condition.

If non-functional diodes are suspected as a result of the test, a combination of the applied bias and infrared imaging of the string of the photovoltaic modules can determine the location of the failed diodes. For example, a diode that has failed (e.g., shorted) may run either hotter or cooler than the diodes operating correctly. A diode that has failed (e.g., open) will result in the solar cells protected by that diode to run hotter than similar solar cells.

In one embodiment, when the string is biased in forward bias at night with an applied current less than or equal to the rated short circuit current of the photovoltaic modules in the string, the photovoltaic modules will emit light in the near infrared region (i.e., about 0.8 to about 1.3 micrometer wavelength). Utilizing a camera that is exclusively sensitive to this wavelength will result in an image of the photovoltaic modules that conveys important information regarding the module quality of operation. This test is referred to as electroluminescence.

Similar the forward bias test described above, the camera can be hand held, mounted in a fixed position, or attached to an unmanned aerial vehicle that can be tethered or not tethered and may include a built-in or separate power supply. Also similar to the forward bias test described above, the timing of the applied power and the image can be synchronized for increased signal to noise.

In the tests described herein where images are being taken by the camera, such methods can be advantageously used to identify specific photovoltaic modules on the image. One method may include attaching a small light source emitting infrared light to the photovoltaic modules as a point of reference. A second method may include attaching an RFID tag that can be remotely sensed to the photovoltaic modules. A third method may include utilizing a GPS signal to locate the camera in reference to the photovoltaic modules being imaged.

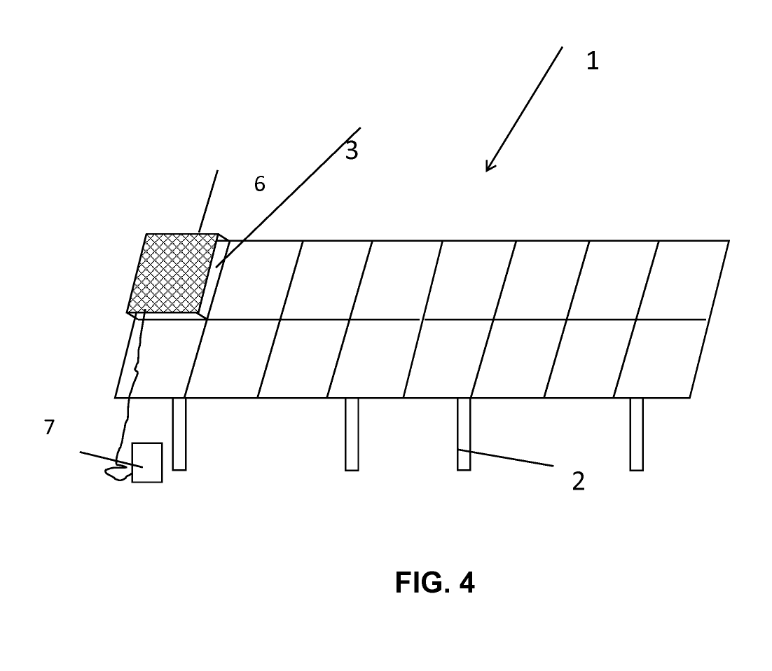

FIG. 4 shows an exemplary photovoltaic array with a light source (and/or shading apparatus) 6 that is detachably attached. A power source 7 for the light source 6 is shown in FIG. 4 as being separate from the light source 6, but may be optionally built into the light source 6. The string of photovoltaic modules containing the module being tested may be biased to a range of current and voltage conditions (IV sweep) while being subjected to the light source or shading apparatus 6. Alternatively, just the photovoltaic module being tested could be biased. The data from the IV sweep can be transferred wirelessly, or via a wire, to a computer at a nearby mobile testing station or a remote central testing station. That same computer can operate, and/or monitor, the power source 7 and data acquisition unit 6 wirelessly, or via a wire. Multiple modules may be covered with the apparatus, or multiple apparatus, at the same time.

According to one embodiment, a method of measuring DC voltage within a photoelectric module can be done by using an electrostatic meter and a non-contact method of measurement. In such a method, with the photovoltaic module biased through an external power supply, or with the photovoltaic module operating under sunlight, the DC voltage of the photovoltaic module can be measured by placing the electrostatic meter close to the surface of the photovoltaic module. This method can be used to localize breaks in strings or shorts in strings or any other type of defect that results in a disturbance to the normal voltage profile across a string of photovoltaic modules.

Theoretically, a voltage map of the photovoltaic module system may be constructed if an automated method of measuring thousands of voltage points across the field and the information within such a map could be processed to locate problems with the system. Such Measurements could be made at the backsheet or glass side of a photovoltaic module.

While the invention herein disclosed has been described by means of specific embodiments, examples and applications thereof, numerous modifications and variations could be made thereto by those skilled in the art without departing from the scope of the invention set forth in the claims.

What is claimed is:

1. A method of testing photovoltaic modules at a location where the photovoltaic modules are installed, the method including passing bias current through the photovoltaic modules at night and imaging the photovoltaic modules with a camera.

2. The method of claim 1, further comprising passing a forward bias current through the photovoltaic modules.

3. The method of claim 1, further comprising passing a reverse bias current through the modules.

4. The method of claim 1, further comprising passing a reverse bias current through the photovoltaic modules at night while recording an effective resistance at fixed voltages.

5. The method of claim 1, further comprising providing a power supply powered by a generator and movable through the location where the photovoltaic modules are installed.

6. The method of claim 1, wherein the camera is configured to capture an infrared image.

7. The method of claim 1, further comprising using the camera to image light in a range of about 0.8 to about 1.3 um range to measure electroluminescence emitted from the photovoltaic modules.

8. The method of claim 1, wherein an entire string of photovoltaic modules is attached to a single power supply.

9. The method of claim 8, wherein the power supply is attached to the string of the photovoltaic modules at a string combiner box.

10. The method of claim 1 further comprising using an image obtained by the camera to identify at least one of: open circuits in a string of photovoltaic modules, cracked solar cells in a string of photovoltaic modules, and poor solder joints in a string of photovoltaic modules.

11. The method of claim 1, further comprising providing a bias point close to a maximum power photovoltaic modules

12. The method of claim 1, further comprising limiting the current by a power supply to a value in a range of about 1 to about 10 A.

13. The method of claim 1, further comprising carrying the camera by an unmanned flying unit.

14. The method of claim 1, further comprising connecting the camera wirelessly to a computer and controlling the camera via the computer to at least one of: -take and download images, calculate position by a global positioning system, and move around the photovoltaic modules to fixed positions and image the photovoltaic modules.

15. The method of claim 13, further comprising tethering the camera to a power supply, and moving the power supply periodically to permit the camera a full range of motion to cover an array of photovoltaic modules.

16. The method of claim 1, further comprising synchronizing the camera to a power supply configured to bias the photovoltaic modules and applying the power and acquiring an image by the camera at the same time and frequency.

17. The method of claim 1, further comprising providing a camera assembly including the camera and positioning the camera assembly directly above a photovoltaic module to test the photovoltaic module.

18. The method of claim 1, further comprising providing a fixed forward or reverse voltage bias to a string of the photovoltaic modules, wherein, when in the forward bias, the current passing through the string is equal to or less than a rated short circuit current of the string, and when in the reverse bias, the current passing through the string is approximately 0.4V times a number of bypass diodes in the string to achieve a current in a range of 5% to 50% of the rated short circuit of the string.

19. A method of identifying photovoltaic modules in an array of the photovoltaic modules, wherein the method includes coupling a light-emitting or signaling device to a photovoltaic module and imaging the light-emitting device or signaling device with one of a camera, a remote sensor, and a measuring device to determine a location of the photovoltaic module in the array.

20. A power generation tester apparatus including a light source placed directly over a photovoltaic module in an array of photovoltaic modules and configured to permit the photovoltaic module to be tested while the photovoltaic module remains mounted in place in the array.
